(19) United States
(12) Patent Application Publication
(10) Pub. No.: US 2025/0259449 A1
(43) Pub. Date: Aug. 14, 2025

(54) EDGE COMPUTING SYSTEM AND METHOD FOR MONITORING CONSTRUCTION SITES

(71) Applicant: AI CLEARING INC., Austin, TX (US)

(72) Inventors: Michal MAZUR, Warsaw (PL); Adam WISNIEWSKI, Warsaw (PL); Jakub LUKASZEWICZ, Warsaw (PL); Dariusz CIESLA, Warsaw (PL)

(21) Appl. No.: 18/867,002

(22) PCT Filed: May 19, 2023
(86) PCT No.: PCT/IB2023/055187

§ 371 Date: Nov. 18, 2024

(30) Foreign Application Priority Data
May 19, 2022 (EP) 22174345.3

(51) Int. Cl. G06V 20/52; G06Q 10/0631; G06T 7/00; G06V 20/17

(52) U.S. Cl. CPC G06V 20/52; G06Q 10/063114; G06T 7/0006; G06V 20/17; G06T 2207/30164; G06V 2201/07

(57) ABSTRACT

The present invention relates to an edge computing system comprising a data processing unit, the data processing unit configured to generate a status data element based on an image of an area, and send the status data element to a remote component, wherein the image comprises an aerial image of the area, wherein the edge computing system, particularly the data processing unit thereof, is configured to receive a data stream from a sensor, and wherein a time interval between receiving the data stream and generating the status data element is less than 30 minutes, preferably less than 10 minutes, further preferably less than 1 minute. The present invention also relates to an associated method, and to an aerial vehicle comprising the edge computing system.

### FIELD

The present invention relates generally to the field of area monitoring. More particularly, it relates to an aerial vehicle, comprising an edge computing system, configured for monitoring a construction site and sending status updates to a remote computer.

### Background

Edge computing systems are expected to play a significant role in the future. More and more devices are going to get “smart” and get connected to the internet, commonly known as the Internet-of-Things (IoT). Edge computing systems or edge devices comprise devices at the edge of a network, i.e., the last devices in the network. A typical feature of these edge computing systems may be the performance of calculations and allowing other components of the network to only access the results of these calculations. This may be of advantage in enhancing the privacy and performance of the IoT. Aerial vehicles, such as drones, may be of interest as edge devices for various applications, such as construction site monitoring.

A drone, equipped with a plurality of sensors comprising a camera, for example, may be configured to fly over a construction site and gather data using each of the plurality of sensors. Typically, data gathered by the drone may have to be sent to a remote computer, or uploaded on to a cloud for further processing. This may lead to higher latency between acquisition of data and obtaining results based on the data. While this may not be a significant disadvantage, the higher latency may be of interest when time-critical information about the construction site is sought. Such time-critical information may comprise, for example, information about safety of constructions workers on the site. It may be of advantage in such scenarios to obtain information about the construction site with as low a latency as possible.

U.S. Pat. No. 10,339,663 B2 discloses systems and methods for generating georeference information with respect to aerial images. In particular, in one or more embodiments, systems and methods generate georeference information relating to aerial images captured without ground control points based on existing aerial images. For example, systems and methods can access a new set of aerial images without ground control points and utilize existing aerial images containing ground control points to generate a georeferenced representation corresponding to the features of the new set of aerial images. Similarly, systems and methods can access a new image without ground control points and utilize an existing georeferenced orthomap to produce a georeferenced orthomap corresponding to the features of the new image. One or more embodiments of the disclosed systems and methods permit users to obtain georeference information related to new images without the need to place ground control points or collect additional georeference information.

U.S. Pat. No. 10,593,108 B2 discloses systems and methods for more efficiently and quickly utilizing digital aerial images to generate models of a site. In particular, in one or more embodiments, the disclosed systems and methods capture a plurality of digital aerial images of a site. Moreover, the disclosed systems and methods can cluster the plurality of digital aerial images based on a variety of factors, such as visual contents, capture position, or capture time of the digital aerial images. Moreover, the disclosed systems and methods can analyse the clusters independently (i.e., in parallel) to generate cluster models. Further, the disclosed systems and methods can merge the cluster models to generate a model of the site.

U.S. Pat. No. 9,389,084 B2 is directed toward systems and methods for identifying changes to a target site based on aerial images of the target site. For example, systems and methods described herein generate representations of the target site based on aerial photographs provided by an unmanned aerial vehicle. In one or more embodiments, systems and method described herein identify differences between the generated representations in order to detect changes that have occurred at the target site.

While the prior art approaches may be satisfactory in some regards, they have certain shortcomings and disadvantages. For example, objects must still be identified, e.g., on orthophoto maps or ortho mosaics generated based on the aerial images.

Also, the reality of construction site does not make things easier. Objects that we aim to track using remote sensing technology are often dirty, covered in mud, or simply hard to distinguish from many similarly looking elements on construction site.

### SUMMARY

It is therefore an object of the invention to overcome or at least alleviate the shortcomings and disadvantages of the prior art. More particularly, it is an object of the present invention to provide an edge computing system, a method, an aerial vehicle comprising the edge computing system, and a computer program product for safer, more efficient control of constructional sites and/or analysis of aerial images.

It is an optional object of the invention to provide a system and method for identifying objects in an area.

It is another optional object of the invention to provide a system and method for identifying objects in an area with an increased precision.

In the following a method and a system are described. Wherever features of a system are described, the method is also embraced by respective method steps and vice-versa.

According to a first aspect, the present invention relates to an edge computing system configured to generate a status data element based on an image of an area, and to send the status data element to a remote component. The edge computing system may comprise a system at the edge of a network (that comprises the edge computing system and the remote component), i.e., it may be the most peripheral computing unit of a network. For example, the edge computing system may comprise the computing unit of an aerial vehicle. The edge computing system may be configured to carry out, for example, calculations and only make visible results of such calculations to other components, such as the remote component, of the network. The status data element may comprise data related to the status of the area—for example, the area may comprise a construction site and the status data element may comprise data relating to progress of the construction. The remote component may comprise a computer, a smartphone, a laptop, a tablet, a cloud computing server, or any other computing device that is at a physical location different from the edge computing system. The image may comprise an aerial image of the area.

The edge computing system may comprise a data processing unit, the data processing unit configured to generate the status data element based on the image of an area, and to send the status data element to the remote component.

The edge computing system may comprise a data storage unit.

The data storage unit may be configured to store at least one module configured to carry out a defined operation based on the image. The defined operation may comprise operations such as generating a heatmap based on the image, or segmentation of the image and further processing based on the segmented image. The data processing unit may be configured to retrieve the at least one module from the data storage unit.

The at least one module may comprise a plurality of modules. The data processing unit may be configured to retrieve any of the plurality of modules from the data storage unit.

The data processing unit may be configured to determine a result of executing any of the at least one module. In particular, the data processing unit may determine the result of executing each of the at least one module.

The status data element may comprise the result of executing any of the at least one module. In particular, the status data element may comprise the result of executing each of the at least one module.

The edge computing system, particularly the data processing unit thereof, may be configured to identify an image object in the image. The image object may be understood to comprise an object identified in the image that corresponds to a real-world object. The object may comprise any of, for example, a person, a protective equipment, or a crack in the surface. Identification of the image object may comprise, for example, determining a rectangular region of the image (identified by means of the pixels at the 4 corners, for example) that corresponds to the identified image object. Further, the edge computing system may be configured to identify a plurality of image objects in the image.

The at least one module as described above may comprise a segmentation module configured to identify the image object. The segmentation module may take, for example, the image of the area as an input, and return, as an output, (optionally) the image and the image object(s). The output may comprise, for example, the image with a label assigned to each pixel. Alternatively, the segmentation module may return edges around different objects in the image. Generally, it may be understood that the segmentation module may be configured to segment the image into image objects using a suitable technique.

The data storage unit as described above may be configured to store a trained neural network, particularly a trained convolutional neural network. The trained convolutional network may be trained separately from the edge computing system, on a training set that may comprise, for example, images of the area with the different segments marked.

The segmentation module described above may be configured to identify the image object by means of the trained neural network.

The edge computing system, particularly the data processing unit thereof, may be configured to assign, from a list of classes, a class to the image object. The list of classes may be determined based on the area depicted in the image and/or on the desired output. For example, a certain area may be monitored for safety and the list of classes may then contain a class relating to “safety equipment”.

The at least one module described above may comprise a classification module configured to assign the class to the image object. In other words, the classification module may be configured to accept as input the image and the image object(s), and to assign the class to at least one of the image object(s).

The classification module may be configured to assign the class by means of the trained neural network. The neural network may be trained based on image objects of a known class identified in other images of the area, for example. Or, the images may be of an area substantially similar to the area for which the status data element is generated. For example, the area may comprise a construction site and images from another construction site may be used for training the neural network.

The at least one module described above may comprise a feature detection module configured, based on the class of the image object, to detect a presence of a feature in the image object. For example, as described above, the edge computing system may be used for monitoring the safety of a construction site. In this case, the image object may comprise a class “person” and the feature detection module may be configured to determine the presence of a helmet on the person's head.

The at least one module described above may comprise a counting module configured to determine a number of image objects comprised in any of the classes in the list of classes. This may be of particular advantage in taking stock of equipment on a construction site, for example. This may be of further advantage in tacking stock of protective equipment on the construction site, for example.

The data storage unit may be configured to store design data. The design data may comprise data relating to a proposed design to be erected on the area. The design data may then comprise, for example, the desired elevation, with respect to a reference surface, at every location in the area.

The at least one module described above may comprise a comparison module configured to compare the image of the area with the design data.

The edge computing system may be configured to identify, in the design data, a design object corresponding to the image object. Such an object is, herein, referred to as the corresponding design object.

The comparison may be based, at least in part, on a comparison of the image object and the corresponding design object. The comparison may comprise, for example, a volumetric comparison. The volumetric comparison may comprise, for example, determining a volume of the image object and comparing it to a volume of the corresponding design object.

The edge computing system, particularly the data processing unit thereof, may be configured to receive a data stream from a sensor. The data stream from the sensor may be understood to comprise the raw data received from the sensor, that may be further processed by the data processing unit. For example, the sensor may comprise a photon sensor configured to at least capture photons incident on a screen. Or, the sensor may comprise an air pressure sensor configured, for example, to detect sound emanating from the area. The data processing unit may then be appropriately configured to process the air pressure data.

The data processing unit may be configured to generate the image from the data stream. The image may be generated from the raw data of e.g., the photon sensor, and may comprise, for example, assigning an RGB color to each pixel based on the spectrum of photons received at the pixel.

The data processing unit may be configured to generate a digital elevation model from the data stream. The digital elevation model may comprise the elevation measured by the sensor for a plurality of locations surveyed by the sensor. The digital elevation model may be of significant advantage in carrying out the volumetric comparison described above. For example, the volumetric comparison may comprise approximating the image object by a polygon, choosing representative vertices on the polygon, projecting the representative vertices on to the digital elevation model to determine an elevation for each of the representative vertices, generating a reference surface for the image object (that may approximate a lower end of the object corresponding to the image object), and determining the volume between the reference surface and a surface comprising the representative vertices. As may be appreciated, the data processing unit may be configured to only determine an elevation for the representative vertices and this is to be understood to also be comprised in “generating a digital elevation model from the data stream”.

The image may comprise an orthophoto map. The orthophoto map may be generated by correcting the raw data for geometric distortions arising from, for example, capturing photons incident at a sensor from a plurality of angles. The orthophoto map may represent the area as apparent from a photon sensor at infinite height and looking down on the area vertically.

The edge computing system may be configured to store the image in the data storage unit. The image may be stored together with other data relating to the capture of the data used to generate the image comprising, for example, a time of capture of the data, or a position of at least one location depicted in the image.

The edge computing system may be configured to store the image based on a result of the comparison between the image and the design data as described above. For example, a pre-defined threshold for a difference between the volume of the image object and the volume of the corresponding design object may be stored on the data storage unit and the image may be stored when the difference is less than the pre-defined threshold.

The edge computing system may be configured to receive an input from the remote component. The input may be received after the status data element has been sent to the remote component.

The edge computing system may be configured to store the image in the data storage unit based on the input from the remote component. The input may comprise, for example, instructions causing the edge computing system to copy the generated image from the data processing unit to the data storage unit. The remote component may be configured to check a pre-defined condition based on the data comprised in the status data element. The input may be sent out from the remote component based on a result of the check of the pre-defined condition.

The at least one module described above may comprise a safety assessment module configured to determine a safety level of the area based on the image. The safety level may be based on at least one or a plurality of safety measurements carried out by the safety assessment module, for example. A safety measurement may comprise, for example, determining an areal density of safety equipment detected in the image. In embodiments, the safety level may comprise only the results of the safety measurements. However, the safety level may also comprise, for example, determining a single number/grade based on the at least one safety measurement, that may involve, for example, taking an appropriate weighted average of the at least one or the plurality of safety measurements.

The sensor described above may comprise a camera. The camera may comprise any of an optical camera, an infrared camera, or a hyperspectral camera.

The sensor may comprise any of a LIDAR (Light Detection and Ranging) sensor, or a radar sensor. The LIDAR sensor may be of particular advantage, for example, in low ambient brightness that may make it difficult for the camera to capture photons. The LIDAR sensor may further be of advantage in improving the precision of the measurement.

The edge computing system may be configured to receive data based on data received from a satellite. The data from the satellite may be used to determine a position of the edge computing system, or of a device in which the edge computing system may be comprised, for example.

The edge computing system may be configured for image photogrammetry.

The area may comprise a construction site. The edge computing system may then be used for monitoring, for example, progress on the construction site.

The edge computing system may be configured to communicate with the remote component by means of a wireless network.

The edge computing system may be further configured to send the image of the area to the remote component.

The edge computing system may be configured to send the image over the wireless network.

The image may be sent to the remote component when a rate of data transfer on the wireless network is at least 30 Mb/s, preferably at least 60 Mb/s, further preferably at least 150 Mb/s. Thus, for example, the edge computing system may be configured to determine a rate of data transfer on the network, and based on a result of the determination, send the image to the remote component. The edge computing system may also be configured to determine the amount of data to encapsulate in the status data element based on the determined rate of data transfer. For example, when the rate of data transfer is less than 1000 KB/min, the status data element may not comprise data relating to the comparison between the image and the design data as described above. Alternatively, when the rate of data transfer is between 1000 KB/min and 10000 KB/min, the status data element may also comprise data relating to the comparison between the image and the design data. Further, when the rate of data transfer exceeds 30 Mb/s, the status data element may also comprise the generated image. Thus, the edge computing system may be used, for example, to also transfer real-time video feed with different image objects marked out in the image, and potential safety issues also demarcated.

The edge computing system may be configured to transfer content from the data storage unit to the remote component. This transfer may be carried out, for example, when the remote component and the edge computing system are in close proximity, and may be accomplished by means of a wired connection, for example.

According to a second aspect, the present invention relates to a method comprising: generating a status data element based on an image of an area, and sending the status data element to a remote component.

The image may comprise an aerial image of the area.

The method may further comprise receiving a data stream from a sensor.

The method may comprise generating the image of the area based on the data stream from the sensor.

The image may comprise an orthophoto map of the area.

Generating the status data element may comprise identifying at least one image object in the image.

Generating the status data element may comprise identifying a plurality of image objects in the image.

Generating the status data element may comprise assigning a position to at least one pixel in the image. The position may be assigned with reference to some defined origin. The defined origin and/or the position assigned to the at least one pixel may preferably correspond to a location on earth. Thus, for example, assigning the position may comprise assigning a latitude and a longitude to the location corresponding to the at least one pixel.

Generating the status data element may comprise assigning a position to a plurality of pixels in the image.

The method may comprise assigning a position to a pixel comprised in the image object.

The status data element may comprise the position assigned to a pixel comprised in the image object.

The method may comprise determining an elevation corresponding to at least one pixel in the image.

The method may comprise generating a digital elevation model of the area.

The method may comprise generating a reference surface of the area.

The method may comprise receiving design data.

The method may comprise identifying, in the design data, a design object corresponding to the image object.

Identifying the corresponding design object in the design data may be based, at least in part, on the position assigned to a pixel comprised in the identified object. For example, the position of the image object (or at least one pixel therein) may be determined as described above. The design data may comprise data relating to the position of the objects as well, and the position of the image object may then be used to identify the corresponding design object.

The method may further comprise comparing the image object and the corresponding design object.

The comparison between the image object and the corresponding design object may be based, at least in part, on the digital elevation model of the area.

The comparison between the image object and the corresponding design object may be based, at least in part, on the orthophoto map of the area described above.

The status data element may further comprise data relating to a result of the comparison between the image object and the corresponding design object.

The method may further comprise storing the image of the area in a data storage unit.

The method may comprise storing the image based on the result of the comparison between the image object and the corresponding design object.

The method may further comprise transferring contents of the data storage unit to the remote component.

The method may comprise receiving an input from the remote component.

The method may comprise storing the image based on the input.

The input may be received after the status data element based on the image has been sent to the remote component.

The method may comprise assigning, from a list of classes, a class to the image object.

The method may comprise, based on the class of the image object, further processing of the image object.

The further processing may comprise determining a presence of a feature in the image object.

The status data element may comprise data relating to a result of the determination of the presence of a feature in the image object.

The method may further comprise determining a number of image objects in a defined class.

The status data element may further comprise data relating to the number of image objects in the defined class.

The method may further comprise determining a safety level of the area based on the image.

The safety level may be based, at least in part, on a result of the determination of the presence of a feature in the image object. For example, the safety level may comprise a percentage of determinations of the presence of a feature that resulted in success, wherein the feature may correspond to a safety feature. For example, the class of the image object may be “person” and the feature may be “helmet”.

The safety level may be based, at least in part, on the number of image objects in the defined class.

The image object may be identified by means of an edge detection algorithm.

The image object may be identified by means of segmentation.

The corresponding design object described above may be identified by means of segmentation.

The segmentation may be carried out by means of a convolutional neural network.

The class described above may be assigned by means of a convolutional neural network.

The detection of the presence of the feature described above may be carried out by means of a convolutional neural network.

A time interval between generating the status data element and sending the status data element to the remote component may be less than 10 minutes, preferably less than 5 minutes, further preferably less than 1 minute.

A rate of transferring the status data element to the remote component may be at least 10 KB/min, preferably at least 100 KB/min, further preferably at least 1000 KB/min.

A time interval between receiving the data stream and generating the status data element is less than 30 minutes, preferably less than 10 minutes, further preferably less than 1 minute. Thus, for example, when the edge computing system as described above, is comprised in an aerial vehicle, such as a drone, the edge computing system may be employed to carry out real-time monitoring of the area.

The edge computing system as described above may be configured to perform the method as described above.

According to a third aspect, the present invention relates to an aerial vehicle comprising an edge computing system and a sensor configured for: flying over an area, gathering data by means of the sensor, and sending the data to the edge computing system.

The edge computing system may comprise an edge computing system as described above.

The aerial vehicle, particularly the edge computing system thereof, may be further configured to communicate with a remote component.

A flight path may be configured to be loaded on to the aerial vehicle, particularly the edge computing system thereof. The flight path may be understood to comprise at least a start position of the flight, and an end position of the flight. The flight path may further comprise other positions in the path, wherein any position may comprise, for example, a latitude and a longitude of the location directly underneath the aerial vehicle, and an altitude of the aerial vehicle.

The aerial vehicle, particularly the edge computing system thereof, may be configured to transfer data to the remote component after the end of the flight.

At least one module may be configured to be loaded on to the aerial vehicle, particularly the edge computing system thereof.

The at least one module loaded may be based, at least in part, on the area.

The at least one module loaded may be based, at least in part, on the flight path.

A time interval between the aerial vehicle gathering data by means of the sensor, and the aerial vehicle, particularly the edge computing system thereof, sending the status data element to the remote component may be less than 1 hour, preferably less than 30 minutes, further preferably less than 2 minutes.

According to a fourth aspect, the present invention relates to a computer program product comprising instructions, when run on a data processing unit of a system as described above, to perform the method as described above.

According to a fifth aspect, the present invention relates to a computer program product comprising instructions, when executed by a computer, to perform the method as described above.

Below, embodiments of an edge computing system will be discussed. These embodiments are abbreviated by the letter “S” followed by a number. Whenever reference is herein made to the “system embodiments”, these embodiments are meant.

S1. An edge computing system configured to: generate a status data element based on an image of an area, and send the status data element to a remote component.
S2. The edge computing system according to the preceding embodiment, wherein the edge computing system comprises a data processing unit, the data processing unit configured to
a. generate the status data element based on the image of an area, and
b. send the status data element to the remote component.
   S3. The edge computing system according to any of the 2 preceding embodiments, wherein the edge computing system comprises a data storage unit.
   S4. The edge computing system according to the preceding embodiment, wherein the data storage unit is configured to store at least one module configured to carry out a defined operation based on the image.
   S5. The edge computing system according to the preceding embodiment, wherein the at least one module comprises a plurality of modules.
   S6. The edge computing system according to any of the 2 preceding embodiments, wherein the data processing unit is configured to determine a result of executing any of the at least one module.
   S7. The edge computing system according to the preceding embodiment, wherein the status data element comprises the result of executing any of the at least one module.
   S8. The edge computing system according to any of the preceding system embodiments and with the features of embodiment S2, wherein the edge computing system, particularly the data processing unit thereof, is configured to identify an image object in the image.
   S9. The edge computing system according to the preceding embodiment and with the features of embodiment S4, wherein the at least one module comprises a segmentation module configured to identify the image object.
   S10. The edge computing system according to any of the preceding system embodiments and with the features of embodiment S3, wherein the data storage unit is configured to store a trained neural network, particularly a trained convolutional neural network.
   S11. The edge computing system according to the preceding embodiment and with the features of the penultimate embodiment, wherein the segmentation module is configured to identify the image object by means of the trained neural network.
   S12. The edge computing system according to any of the preceding system embodiments and with the features of embodiment S8, wherein the edge computing system, particularly the data processing unit thereof, is configured to assign, from a list of classes, a class to the image object.
   S13. The edge computing system according to the preceding embodiment and with the features of embodiment S4, wherein the at least one module comprises a classification module configured to assign the class to the image object.
   S14. The edge computing system according to the preceding embodiment and with the features of embodiment S10, wherein the classification module is configured to assign the class by means of the trained neural network.
   S15. The edge computing system according to any of the 3 preceding embodiments and with the features of embodiment S4, wherein the at least one module comprises a feature detection module configured, based on the class of the image object, to detect a presence of a feature in the image object.
   S16. The edge computing system according to any of the 4 preceding embodiments and with the features of embodiment S4, wherein the at least one module comprises a counting module configured to determine a number of image objects comprised in any of the classes in the list of classes.
   S17. The edge computing system according to any of the preceding system embodiments and with the features of embodiment S3, wherein the data storage unit is configured to store design data.
   S18. The edge computing system according to the preceding embodiment and with the features of embodiment S4, wherein the at least one module comprises a comparison module configured to compare the image of the area with the design data.
   S19. The edge computing system according to the preceding embodiment and with the features of embodiment S8, wherein the edge computing system is configured to identify, in the design data, a design object corresponding to the image object.
   S20. The edge computing system according to the preceding embodiment, wherein the comparison is based, at least in part, on a comparison of the image object and the corresponding design object.
   S21. The edge computing system according to any of the preceding system embodiments and with the features of embodiment S2, wherein the edge computing system, particularly the data processing unit thereof, is configured to receive a data stream from a sensor.
   S22. The edge computing system according to the preceding embodiment, wherein the data processing unit is configured to generate the image from the data stream.
   S23. The edge computing system according to any of the 2 preceding embodiments, wherein the data processing unit is configured to generate a digital elevation model from the data stream.
   S24. The edge computing system according to any of the 2 preceding embodiments, wherein the image comprises an orthophoto map.
   S25. The edge computing system according to any of the preceding system embodiments and with the features of embodiment S3, wherein the edge computing system is configured to store the image in the data storage unit.
   S26. The edge computing system according to the preceding embodiment and with the features of embodiment S18, wherein the edge computing system is configured to store the image based on a result of the comparison between the image and the design data.
   S27. The edge computing system according to any of the preceding system embodiments, wherein the edge computing system is configured to receive an input from the remote component.
   S28. The edge computing system according to the preceding embodiment and with the features of embodiment S3, wherein the edge computing system is configured to store the image in the data storage unit based on the input from the remote component.
   S29. The edge computing system according to any of the preceding system embodiments and with the features of embodiment S4, wherein the at least one module comprises a safety assessment module configured to determine a safety level of the area based on the image.
   S30. The edge computing system according to any of the preceding system embodiments and with the features of embodiment S21, wherein the sensor comprises a camera.
   S31. The edge computing system according to the preceding embodiment, wherein the camera comprises any of an optical camera, an infrared camera, or a hyperspectral camera.
   S32. The edge computing system according to any of the preceding system embodiments and with the features of embodiment SS21, wherein the sensor comprises any of a lidar sensor, or a radar sensor.
   S33. The edge computing system according to any of the preceding system embodiments, wherein the edge computing system is configured to receive data based on data received from a satellite.
   S34. The edge computing system according to any of the preceding system embodiments, wherein the edge computing system is configured for image photogrammetry.
   S35. The edge computing system according to any of the preceding system embodiments, wherein the area comprises a construction site.
   S36. The edge computing system according to any of the preceding system embodiments, wherein the edge computing system is configured to communicate with the remote component by means of a wireless network.
   S36. The edge computing system according to any of the preceding system embodiments, wherein the edge computing system is further configured to send the image of the area to the remote component.
   S37. The edge computing system according to the preceding embodiment and with the features of embodiment S36, wherein the edge computing system is configured to send the image over the wireless network.
   S38. The edge computing system according to the preceding embodiment, wherein the image is sent to the remote component when a rate of data transfer on the wireless network is at least 30 Mb/s, preferably at least 60 Mb/s, further preferably at least 150 Mb/s.
   S39. The edge computing system according to any of the preceding system embodiments and with the features of embodiment S3, wherein the edge computing system is configured to transfer content from the data storage unit to the remote component.
   S40. The edge computing system according to any of the preceding system embodiments, wherein a time interval between generating the status data element and sending the status data element to the remote component is less than 10 minutes, preferably less than 5 minutes, further preferably less than 1 minute.
   S41. The edge computing system according to any of the preceding system embodiments and with the features of embodiment S21, wherein a time interval between receiving the data stream and generating the status data element is less than 30 minutes, preferably less than 10 minutes, further preferably less than 1 minute.

Below, embodiments of a method will be discussed. These embodiments are abbreviated by the letter “M” followed by a number. Whenever reference is herein made to the “method embodiments”, these embodiments are meant.

M1. A method comprising:
a. generating a status data element based on an image of an area, and
b. sending the status data element to a remote component.
   M2. The method according to the preceding embodiment, wherein the image comprises an aerial image of the area.
   M3. The method according to any of the preceding method embodiments, wherein the method further comprises receiving a data stream from a sensor.
   M4. The method according to the preceding embodiment, wherein the method comprises generating the image of the area based on the data stream from the sensor.
   M5. The method according to the preceding embodiment, wherein the image comprises an orthophoto map of the area.
   M6. The method according to any of the preceding method embodiments, wherein generating the status data element comprises identifying at least one image object in the image.
   M7. The method according to the preceding embodiment, wherein generating the status data element comprises identifying a plurality of image objects in the image.
   M8. The method according to any of the preceding method embodiments, wherein generating the status data element comprises assigning a position to at least one pixel in the image.
   M9. The method according to the preceding embodiment, wherein generating the status data element comprises assigning a position to a plurality of pixels in the image.
   M10. The method according to any of the 2 preceding embodiments and with the features of embodiment M6, wherein the method comprises assigning a position to a pixel comprised in the image object.
   M11. The method according to the preceding embodiment, wherein the status data element comprises the position assigned to a pixel comprised in the image object.
   M12. The method according to any of the preceding method embodiments, wherein the method comprises determining an elevation corresponding to at least one pixel in the image.
   M13. The method according to the preceding embodiment, wherein the method comprises generating a digital elevation model of the area.
   M14. The method according to the preceding embodiment, wherein the method comprises generating a reference surface of the area.
   M15. The method according to any of the preceding method embodiments, wherein the method comprises receiving design data.
   M16. The method according to the preceding embodiment and with the features of embodiment M6, wherein the method comprises identifying, in the design data, a design object corresponding to the image object.
   M17. The method according to the preceding embodiment and with the features of embodiment M11, wherein identifying the corresponding design object in the design data is based, at least in part, on the position assigned to a pixel comprised in the identified object.
   M18. The method according to the preceding embodiment, wherein the method further comprises comparing the image object and the corresponding design object.
   M19. The method according to the preceding embodiment and with the features of embodiment M13, wherein the comparison between the image object and the corresponding design object is based, at least in part, on the digital elevation model of the area.
   M20. The method according to any of the 2 preceding embodiments and with the features of embodiment M5, wherein the comparison between the image object and the corresponding design object is based, at least in part, on the orthophoto map of the area.
   M21. The method according to any of the preceding method embodiments and with the features of embodiment M18, wherein the status data element further comprises data relating to a result of the comparison between the image object and the corresponding design object.
   M22. The method according to any of the preceding method embodiments, wherein the method further comprises storing the image of the area in a data storage unit.
   M23. The method according to the preceding embodiment and with the features of embodiment M20, wherein the method comprises storing the image based on the result of the comparison between the image object and the corresponding design object.
   M24. The method according to any of the 2 preceding embodiments, wherein the method further comprises transferring contents of the data storage unit to the remote component.
   M25. The method according to any of the preceding method embodiments, wherein the method comprises receiving an input from the remote component.
   M26. The method according to the preceding embodiment and with the features of embodiment M22, wherein the method comprises storing the image based on the input.
   M27. The method according to any of the 2 preceding method embodiments, wherein the input is received after the status data element based on the image has been sent to the remote component.
   M28. The method according to any of the preceding method embodiments and with the features of embodiment M6, wherein the method comprises assigning, from a list of classes, a class to the image object.
   M29. The method according to the preceding embodiment, wherein the method comprises, based on the class of the image object, further processing of the image object.
   M30. The method according to the preceding embodiment, wherein the further processing comprises determining a presence of a feature in the image object.
   M31. The method according to the preceding embodiment, wherein the status data element comprises data relating to a result of the determination of the presence of a feature in the image object.
   M32. The method according to any of the preceding method embodiments and with the features of embodiment M28, wherein the method further comprises determining a number of image objects in a defined class.
   M33. The method according to the preceding embodiment, wherein the status data element further comprises data relating to the number of image objects in the defined class.
   M34. The method according to any of the preceding method embodiments, wherein the method further comprises determining a safety level of the area based on the image.
   M35. The method according to the preceding embodiment and with the features of embodiment M30, wherein the safety level is based, at least in part, on a result of the determination of the presence of a feature in the image object.
   M36. The method according to any of the 2 preceding embodiments and with the features of embodiment M33, wherein the safety level is based, at least in part, on the number of image objects in the defined class.
   M37. The method according to any of the preceding method embodiments and with the features of embodiment M6, wherein the image object is identified by means of an edge detection algorithm.
   M38. The method according to any of the preceding method embodiments and with the features of embodiment M6, wherein the image object is identified by means of segmentation.
   M39. The method according to any of the preceding method embodiments and with the features of embodiment M16, wherein the corresponding design object is identified by means of segmentation.
   M40. The method according to any of the 2 preceding embodiments, wherein the segmentation is carried out by means of a convolutional neural network.
   M41. The method according to any of the preceding method embodiments and with the features of embodiment M28, wherein the class is assigned by means of a convolutional neural network.
   M42. The method according to any of the preceding method embodiments and with the features of embodiment M31, wherein the detection of the presence of the feature is carried out by means of a convolutional neural network.
   M43. The method according to any of the preceding method embodiments, wherein a time interval between generating the status data element and sending the status data element to the remote component is less than 10 minutes, preferably less than 5 minutes, further preferably less than 1 minute.
   M44. The method according to any of the preceding method embodiments, wherein a rate of transferring the status data element to the remote component is between at least 10 KB/min, preferably at least 100 KB/min, further preferably at least 1000 KB/min.
   M45. The method according to any of the preceding method embodiments and with the features of embodiment M3, wherein a time interval between receiving the data stream and generating the status data element is less than 30 minutes, preferably less than 10 minutes, further preferably less than 1 minute.
   S42. The edge computing system according to any of the preceding system embodiments, wherein the edge computing system is configured to perform the method according to any of the preceding method embodiments.

Below, embodiments of an aerial vehicle will be discussed. These embodiments are abbreviated by the letter “V” followed by a number. Whenever reference is herein made to the “aerial vehicle embodiments”, these embodiments are meant.

V1. An aerial vehicle comprising an edge computing system and a sensor configured for:
flying over an area,
gathering data by means of the sensor, and
sending the data to the edge computing system.
   V2. The aerial vehicle according to the preceding embodiment, wherein the edge computing system comprises an edge computing system according to any of the preceding system embodiments.
   V3. The aerial vehicle according to any of the 2 preceding embodiments, wherein the aerial vehicle, particularly the edge computing system thereof, is further configured to communicate with a remote component.
   V4. The aerial vehicle according to any of the 3 preceding embodiments, wherein a flight path is configured to be loaded on to the aerial vehicle, particularly the edge computing system thereof.
   V5. The aerial vehicle according to the preceding embodiment and with the features of the penultimate embodiment, wherein the aerial vehicle, particularly the edge computing system thereof, is configured to transfer data to the remote component after the end of the flight.
   V6. The aerial vehicle according to any of the 5 preceding embodiments, wherein at least one module is configured to be loaded on to the aerial vehicle, particularly the edge computing system thereof.
   V7. The aerial vehicle according to the preceding embodiment, wherein the at least one module loaded is based, at least in part, on the area.
   V8. The aerial vehicle according to any of the 2 preceding embodiments and with the features of embodiment V4, wherein the at least one module loaded is based, at least in part, on the flight path.
   V9. The aerial vehicle according to any of the preceding aerial vehicle embodiments, wherein a time interval between the aerial vehicle gathering data by means of the sensor, and the aerial vehicle, particularly the edge computing system thereof, sending the status data element to the remote component is less than 1 hour, preferably less than 30 minutes, further preferably less than 2 minutes.

Below, embodiments of a computer program product will be discussed. These embodiments are abbreviated by the letter “P” followed by a number. Whenever reference is herein made to the “computer program product embodiments”, these embodiments are meant.

P1. A computer program product comprising instructions, when run on a data processing unit of a system according to any of the preceding system embodiments, to perform the method according to any of the preceding method embodiments.
P2. A computer program product comprising instructions, when executed by a computer, to perform the method according to any of the preceding method embodiments.

### BRIEF DESCRIPTION OF FIGURES

FIG. 1 depicts a system comprising an edge computing system and a remote component; and

FIG. 2 depicts an aerial vehicle comprising the edge computing system.

### DETAILED FIGURE DESCRIPTION

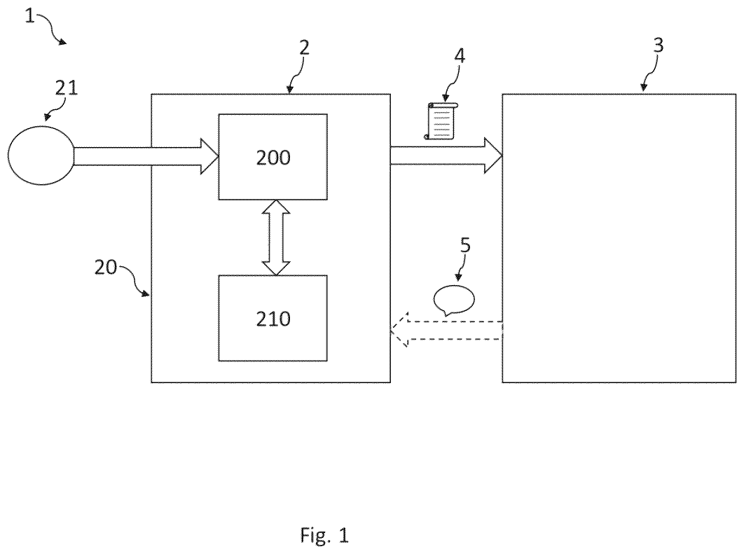

FIG. 1 depicts a system 1 comprising an edge computing system 2 and a remote component 3. The edge computing system 2 is configured to generate a status data element 4 based on an image of an area, and to send the generated status data element 4 to the remote component 3. The image may comprise an aerial image. The remote component 3 may comprise a computer, a smartphone, a tablet, or any other data processing system. The remote component 3 may comprise a part of a cloud network. The edge computing system 2 may be configured to communicate with the remote component 3. The communication may take place over a wireless network. The wireless network may comprise a WiFi network, a cellular network, a Bluetooth connection, or any other suitable means of wireless communication.

FIG. 1 further depicts data flow across various components of the system 1 by means of arrows. For example, an arrow depicts the edge computing system 2 configured to send the status data element 4 to the remote component 3. The status data element 4 may comprise data related to an aspect, preferably a plurality of aspects, of an area as will be described in further detail below. Note that, in the following, whenever the status data element 4 is disclosed to comprise some defined data, it is to be understood to comprise also data related to the defined data. In other words, for example, the defined data may be compressed before being encapsulated in the status data element 4. The data processing unit 200 may be appropriately configured for such transformations of the defined data.

The remote component 2 may also send an input 5 to the edge computing system 2. The edge computing system 2 may comprise a data processing unit 200. The data processing unit 200 may be configured to exchange data with a data storage unit 210. At least one or a plurality of modules may be loaded on to the data storage unit 210. Each of the at least one module may be executed to carry out a defined operation based on the image of the area. The data processing unit 200 may be configured to execute each of the at least one module and to store data related to the result of the execution of each of the at least one module in the status data element 4.

The system 1 may comprise a sensor 21. The sensor 21 may comprise, for example, a camera. The camera may be supported by electromagnetic waves in the optical, or infrared frequencies. The sensor 21 may further comprise a hyperspectral camera configured to determine a spectrum of the captured radiation. The sensor 21 may capture radiation data from an area. The area may comprise, for example, a construction site. The sensor 21 may send the captured data stream to the edge computing system 2, particularly to the data processing unit 200 thereof.

The data processing unit 200 may then generate an image based on the data stream from the sensor 21. The image may comprise an ortho-rectified image, or an orthophoto map, corrected for geometric distortions arising from a position of the sensor 21, for example. The image may comprise an RGB image, or a hyperspectral image with information about the spectrum of light (in a plurality of wavelength bands, for example) captured from the area.

The data processing unit 200 may be further configured to assign a position to at least one pixel in the image of the area. The position may comprise, for example, a latitude and a longitude corresponding to the location of the at least one pixel depicted in the image. The position may be assigned by means of data received by the data processing unit 200 from a satellite, or from a ground-based network. The position may be determined by means of photogrammetry (e.g., Real-Time Kinematic photogrammetry). The data processing unit 200 may be configured to also determine an elevation of the location corresponding to at least one pixel depicted in the image. Thus, the data processing unit 200 may be configured to determine the elevation as well as the latitude and the longitude corresponding to the location of at least one pixel depicted in the image. The data processing unit 200 may further determine any of the elevation or the position of a plurality of pixels in the image. The status data element 4 may comprise the position and/or elevation assigned to at least one pixel in the image.

The data processing unit 200 may be further configured to generate a digital elevation model for the area based on the image of the area and the determined elevation of the location corresponding to at least pixel in the image. The digital elevation model may be stored in the data storage unit 210. The digital elevation model may be compressed, for example, before being stored in the data storage unit 210.

As described above, the data processing unit 200 may be configured to execute each of the at least one module stored in the data storage unit 210. The at least one module may comprise a segmentation module configured to identify/detect an image object in the image. The segmentation may be carried out by any suitable image processing method, such as edge detection. The segmentation module may also identify the image object based on an artificial-intelligence based method. For example, a trained neural network, particularly a trained convolutional neural network, may be stored in the data storage unit 210. The data processing unit 200 may then be configured to segment the image to obtain the image object by means of the trained neural network. The data processing unit 200 may also be configured to identify a plurality of image objects in the image.

The at least one module may further comprise a classification module configured to assign a class to the image object identified as above. The class may comprise any of background (i.e., no object of interest), asphalt, concrete foundation, concrete ring, pipe, tree, black or dark sand, cable well, cars, chipping, container, crack, dump truck, heap of earth, heap of sand, heavy earth equipment, lantern, people, reinforcement, rubble, scaffolding, silo, water, wooden boards, fence, pavement, crushed stone for railways (e.g., for track ballast), concrete grid, paving blocks, aggregate (e.g., for generation of electricity or compressed air), geotextile, sheet piling (such as Larssen sheet piling), artificial rocks, formwork, retaining wall, crane, steel structure, wall, roof, protective equipment, or floor.

The person skilled in the art will easily understand that, instead of assigning the class “background” to a portion, the method may also comprise not assigning a class to said portion or assigning a “null”-class to a portion. It may also be appreciated that the above list is to be considered an exemplary, but not limiting, list of classes that may be used to classify the image object.

The classification may be achieved by means of a trained neural network, preferably a trained convolutional neural network, stored in the data storage unit 210. The trained neural network used for classification may or may not be the same as the trained neural network used for segmentation. Note that the classification module may be configured to operate on the image of the area as a whole or, preferably, on the image object identified by the segmentation module as described above.

Thus, for example, the edge computing system 2 may determine the presence of rubble at a location given by the position of at least one pixel comprised in the plurality of pixels corresponding to the rubble. The status data element 4 may then comprise, for example, an identifier corresponding to the class “rubble” of the image object, and the position of, preferably one representative pixel (or a plurality of representative pixels) corresponding to the rubble. The one representative pixel may, for example, be an average of the all the pixels identified as corresponding to the rubble. Or, a suitable weighting scheme may be applied to a pixel based, for example, on an intensity of radiation detected from a pixel. In general, it may be understood that the status data element 4 may comprise the class of the image object and a measure of its location.

The data storage unit 210 may further store a feature detection module configured to detect, based on the class of the image object, a presence of a feature in the image object. For example, if the class of the image object is “person”, the feature detection module may be configured to detect the presence of a safety helmet on the head of the person. This may, thus, be of significant advantage in monitoring a safety level of the area. The result of the detection of the feature in the image object may also be comprised in the status data element 4.

The feature detection may be achieved by means of a trained neural network, preferably a trained convolutional neural network, stored in the data storage unit 210. The trained neural network used for feature detection may or may not be the same as the trained neural network used for classification or for segmentation. Note that the feature detection module may be configured to operate on the image of the area as a whole or, preferably, on the image object of the defined class.

The at least one module may further comprise a counting module configured to count the number of image objects comprised in a defined class. For example, the counting module may count the number of image object classified as “heavy equipment”, or as “protective equipment”. Note that a given object may be classified into a plurality of classes.

Based on the count of image objects in the defined class, a safety level of the area may be determined. This may be determined by a safety assessment module stored on the data storage unit 210. For example, the safety assessment module may be configured to determine the level of safety by determining the number of image objects labelled “protective equipment” per unit area of the area depicted in the image. Based on this ratio, the safety assessment module may assign, for example, a safety grade to the area depicted. The result of the safety assessment module, that may comprise the safety grade, for example, may also be encapsulated in the status data element 4.

The data storage unit 210 may further store design data for the area. The data processing unit 200 may be configured to identify/detect an object corresponding to the image object in the design data. Such object may be referred to as a corresponding design object. The identification may be based, for example, on the location of the image object and/or on a determined projection of the design object.

The at least one module may further comprise a comparison module configured to compare the image object and the corresponding design object. The comparison may comprise a volumetric comparison, for example. Or, it may comprise an area-based comparison. The comparison may be based on the digital elevation model as described above. In general, it may be understood that a comparison of the image object and the corresponding design object may be made. The status data element 4 may comprise a result of the comparison of the image object and the corresponding design object. The data storage unit 210 may be configured to store the image of the area based on the result of the comparison between the image object and the corresponding design object.

After the status data element 4 has been sent to the remote component 3, the remote component 3 may send the input 5 to the edge computing system 2. Based on the input 5, the edge computing system 2, particularly the data processing unit 200 thereof, may be configured to send the image of the area to the data storage unit 210 for storage. For example, the remote component 3 may inspect the contents of the status data element 4 and send the input 5 based on the contents of the status data element. For example, such input 5 may be generated when the safety level of the area falls below a certain pre-defined threshold. The input 5 may comprise instructions, when executed, to cause the data processing unit 200 to send the image of the area to the data storage unit 210.

A time interval between receiving the data stream from the sensor 21 and generating the status data element 4 may be less than 30 minutes, preferably less than 10 minutes, further preferably less than 1 minute. A time interval between generating the status data element 4 and sending the status data element 4 to the remote component 3 may be less than 10 minutes, preferably less than 5 minutes, further preferably less than 1 minute.

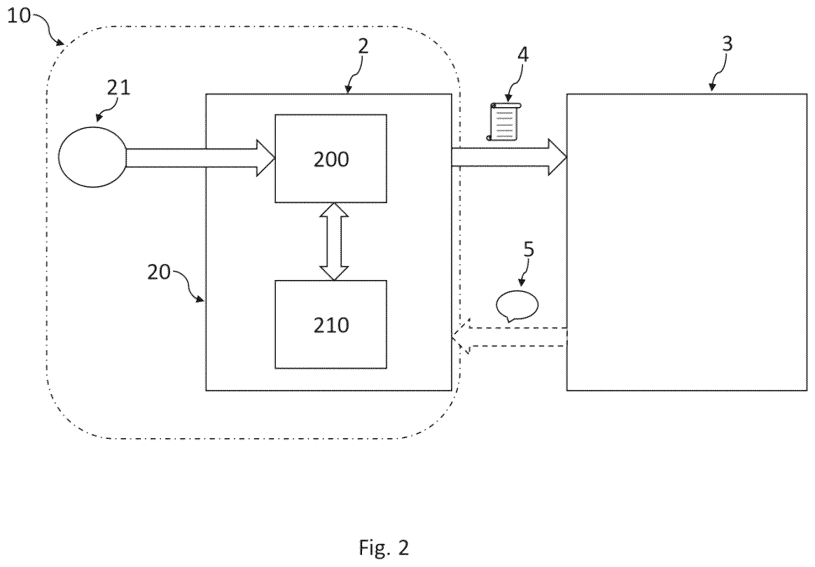

The edge computing system 2 and the sensor 21 may be comprised in an aerial vehicle 10 as depicted in FIG. 2. The aerial vehicle 10 may be configured to fly in a pre-defined path over the area. The pre-defined path may comprise, for example, the positions of the aerial vehicle 10 and its elevation from the surface at the location given by the position. At least one or a plurality of modules may be loaded on to the edge computing system 2, particularly the data storage unit 210 thereof, prior to the flight of the aerial vehicle 10. The at least one or plurality of modules loaded may be based on the pre-defined path of the aerial vehicle 10. For example, only a few modules relating to safety assessment may be loaded on to the data storage unit 210, when safety is to be monitored.

The edge computing system 2, particularly the data storage unit 210 thereof, may be configured to transfer the stored data to the remote component 3. The data transfer may be carried out after the end of the flight of the aerial vehicle 10. The rate of data transfer between the edge computing system 2, particularly the data storage unit 210 thereof, and the remote component 3 may be at least 1 MB/s, preferably at least 2 MB/s, further preferably at least 5 MB/s.

The data processing unit 200 may comprise one or more processing units configured to carry out computer instructions of a program (i.e., machine readable and executable instructions). The processing unit(s) may be singular or plural. For example, the data processing unit 200 may comprise at least one of CPU, GPU, DSP, APU, ASIC, ASIP or FPGA.

The data storage unit 210 may comprise memory components, such as main memory (e.g., RAM), cache memory (e.g., SRAM) and/or secondary memory (e.g. HDD, SDD). The data storage unit 210 may comprise volatile and/or non-volatile memory such as SDRAM, DRAM, SRAM, Flash Memory, MRAM, F-RAM, or P-RAM. The edge computing system 2 may comprise internal communication interfaces (e.g., busses) configured to facilitate electronic data exchange between components of the edge computing system 2, such as, the communication between the data storage unit 210 and the data processing unit 200.

The edge computing system 2 may comprise external communication interfaces configured to facilitate electronic data exchange between the edge computing system 2 and devices or networks external to the edge computing system 2, e.g., for sending the status data element 4 to the remote component 3.

For example, the edge computing system 2 may comprise network interface card(s) that may be configured to connect the edge computing system 2 to a network, such as, to the Internet. The edge computing system 2 may be configured to transfer electronic data using a standardized communication protocol.

To put it simply, the data processing unit 200 may be a processing unit configured to carry out instructions of a program. The edge computing system 2 may be a system on-chip comprising processing units, memory components and busses. The edge computing system 2 may be interfaced with a personal computer, a laptop, a pocket computer, a smartphone, a tablet computer and/or user interfaces.

Further, while an exemplary embodiment of the present invention has been described above, with reference to one data processing unit, and one data storage unit, it may be appreciated that the edge computing system may also comprise a plurality of any of the data processing unit or the data storage unit, without deviating from the present invention.

Overall, embodiments of the present technology are thus directed to an edge computing system and method for monitoring an area, preferably a construction site, that may be of advantage in tracking (quasi) real-time changes in the area, and in improving the safety and environmental-compliance of the area.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, preferred embodiments have been described with reference to the accompanying drawings, the skilled person will understand that these embodiments were provided for illustrative purpose only and should by no means be construed to limit the scope of the present invention, which is defined by the claims.
1-15. (canceled)

16. An edge computing system comprising a data processing unit, the data processing unit configured to
generate a status data element based on an image of an area, and
send the status data element to a remote component,
wherein the image comprises an aerial image of the area,
wherein the edge computing system, particularly the data processing unit thereof, is configured to receive a data stream from a sensor, and wherein
a time interval between receiving the data stream and generating the status data element is less than 30 minutes, preferably less than 10 minutes, further preferably less than 1 minute.

17. The edge computing system according to claim 16, wherein a time interval between generating the status data element and sending the status data element to the remote component is less than 10 minutes, preferably less than 5 minutes, further preferably less than 1 minute.

18. The edge computing system according to claim 16, wherein the edge computing system comprises a data storage unit, wherein the data storage unit is configured to store at least one module configured to carry out a defined operation based on the image.

19. The edge computing system according to claim 18, wherein the data processing unit is configured to determine a result of executing any of the at least one module, and wherein the status data element comprises the result of executing any of the at least one module.

20. The edge computing system according to claim 16, wherein the edge computing system, particularly the data processing unit thereof, is configured to identify an image object in the image.

21. The edge computing system according to claim 18, wherein the data storage unit is configured to store design data.

22. The edge computing system according to claim 21, wherein the at least one module comprises a comparison module configured to compare the image of the area with the design data.

23. The edge computing system according to claim 22, wherein the edge computing system is configured to identify, in the design data, a design object corresponding to the image object, wherein the comparison is based, at least in part, on a comparison of the image object and the corresponding design object.

24. The edge computing system according to claim 16, wherein the image comprises an orthophoto map.

25. The edge computing system according to claim 16, wherein the edge computing system, particularly the data processing unit thereof, is configured to receive a data stream from a sensor.

26. The edge computing system according to claim 25, wherein the sensor comprises a camera, wherein the camera comprises any of an optical camera, an infrared camera, or a hyperspectral camera.

27. The edge computing system according to claim 18, wherein the at least one module comprises a safety assessment module configured to determine a safety level of the area based on the image.

28. The edge computing system according to claim 16, wherein the area comprises a construction site.

29. The edge computing system according to claim 16, wherein the edge computing system is configured for image photogrammetry.

30. A method comprising:
generating a status data element based on an image of an area, and
sending the status data element to a remote component,
wherein the image comprises an aerial image of the area.

31. The method according to claim 30, wherein generating the status data element comprises assigning a position to at least one pixel in the image.

32. The aerial vehicle comprising an edge computing system according to claim 16 and a sensor configured for:
flying over an area,
gathering data by means of the sensor, and
sending the data to the edge computing system, wherein the aerial vehicle, particularly the edge computing system thereof, is further configured to communicate with a remote component.

33. The aerial vehicle according to claim 32, wherein a flight path is configured to be loaded on to the aerial vehicle, particularly the edge computing system thereof.

34. The aerial vehicle according to the claim 32, wherein the edge computing system comprises a data storage unit, wherein the data storage unit is configured to store at least one module configured to carry out a defined operation based on the image, and wherein the at least one module loaded is based, at least in part, on the area and/or on the flight path.

35. The aerial vehicle according to claim 32, wherein a time interval between the aerial vehicle gathering data by means of the sensor, and the aerial vehicle, particularly the edge computing system thereof, sending the status data element to the remote component is less than 1 hour, preferably less than 30 minutes, further preferably less than 2 minutes.
